(19) United States
(12) Patent Application Publication
(10) Pub. No.: US 2013/0140357 A1
(43) Pub. Date: Jun. 6, 2013

(54) Product information distribution

(71) Applicant: Michael Ure, Cupertino, CA (US)

(72) Inventor: Michael Ure, Cupertino, CA (US)

(21) Appl. No.: 13/490,640

(22) Filed: Jun. 7, 2012

Related U.S. Application Data
(60) Provisional application No. 61/495,010, filed on Jun. 9, 2011.

(51) Int. Cl. G06F 17/30; G06K 19/077

(52) U.S. Cl. CPC G06F 17/3082; G06K 19/0776
USPC 235/375; 235/492

(57) ABSTRACT

Systems and methods are provided for quickly and easily displaying additional product information to shoppers. In one embodiment, a mobile electronic device such as a smartphone is provided with an application that allows for input of UPC barcode information or the like. In response, a video is retrieved and presented to the user. The video may describe any of various aspects of the product, including manufacture, use, reliability, durability, etc.

The present invention relates to connected mobile devices and to product information distribution.

Smartphone applications are numerous and include various applications in which product identification information is captured using a smartphone in order to retrieve information related to that product. In one example of such an application, “scanning” a product barcode results in comparison shopping information being retrieved and displayed. A need remains for systems and methods for improved product information distribution.

Systems and methods are provided for quickly and easily displaying additional product information to shoppers. In one embodiment, a mobile electronic device such as a smartphone is provided with an application that allows for input of UPC barcode information or the like. In response, a video is retrieved and presented to the user. The video may describe any of various aspects of the product, including manufacture, use, reliability, durability, etc.

FIG. 1 is a block diagram of a product information distribution system.

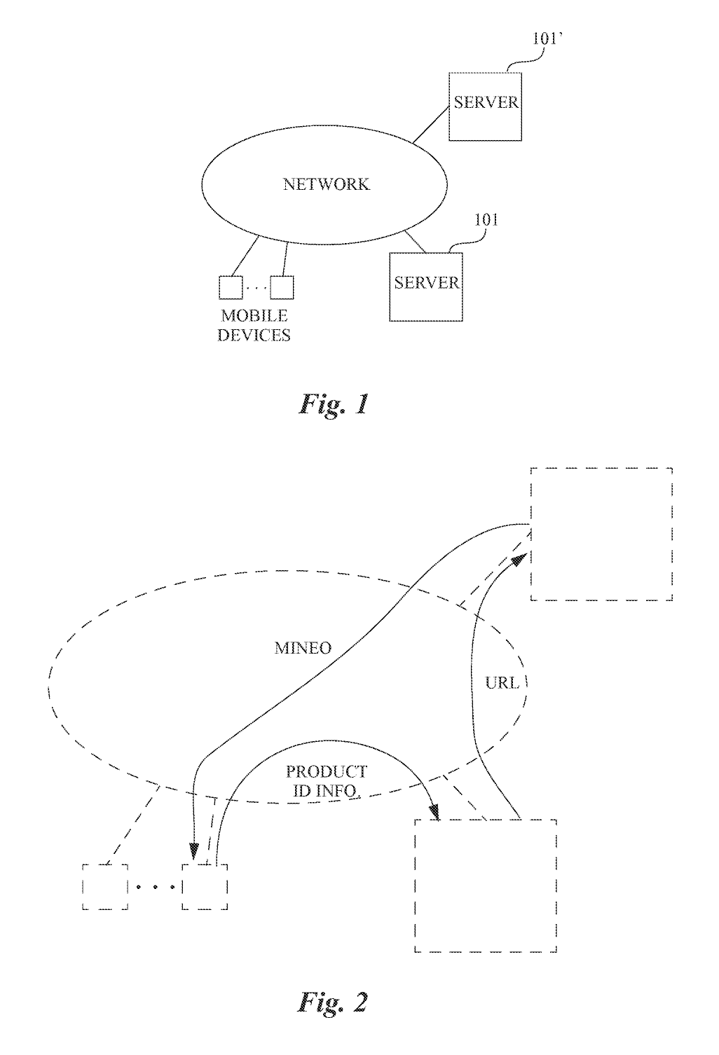

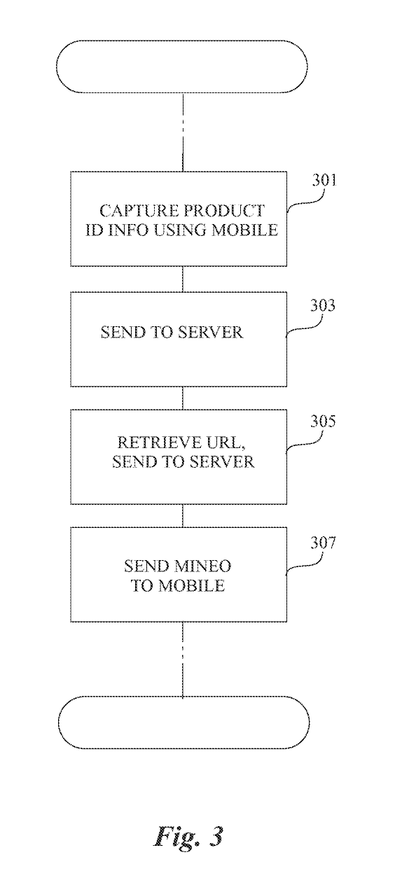

FIG. 2 is a diagram illustrating operation of the product information distribution system of FIG. 1.

FIG. 3 is a diagram illustrating a method of product information distribution.

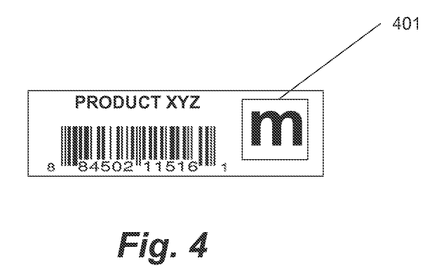

FIG. 4 is a diagram of a shelf tag to which a sticker incorporating an RFID tag is applied, the sticker bearing branding information indicative of the availability of additional product information.

Referring now to FIG. 1, a diagram is shown of a product information distribution system. Various mobile electronic devices are shown, coupled to a network. The mobile electronic devices may be smartphones or the like. The network may be the internet, the cellular network, unlicensed networks, or, in the typical case, some combination thereof. Coupled to the network are various servers including a server 101 and a server 103. The server 101 may be an application server. The server 103 may be a video server such as a YouTube™ server or the like.

Referring to FIG. 2, in one embodiment, operation commences with a mobile electronic device capturing product identification information. Typically, a user will activate an application and within that application will take an action that causes input of UPC barcode information or the like. One such action is to take a picture of a product or of some portion of the product or packaging of the product such as the product's UPC (universal product code), or of a shelf tag. Note that instead of being bar coded, the UPC code may be provided in text form.

Another such action may be to tap a “smart” shelf tag, e.g., a shelf tag that is provided with an RFID tag. The shelf tag may be interrogated by a smartphone equipped with wireless PAN (personal area network) capabilities, such as Near Field Communication (NFC) capabilities. For example, tapping of a smart shelf tag with an NFC-capable smartphone may be detected using an accelerometer of the smartphone, causing the smartphone to interrogate the nearby tag to obtain product information.

Product identification information may be obtained in any of the foregoing ways or in other suitable ways.

The product information obtained may be sent through the network to a server such as the application server 101. The application server 101 receives the product identification information and, if needed, processes it by performing recognition, decoding, etc. The application server may store a mapping between the product identification information and a URL. Typically, product vendors will become service subscribers and will identify products and corresponding URLs. This information is stored accessible to the application server 101 in the form of a mapping. When product identification information is received, the application server 101 may use the foregoing mapping to retrieve a URL corresponding to the product.

The URL may be sent through the network to another server such as the video server 103. The URL is sent in such a way that the video server 103 sends a video identified by the URL to the originating mobile electronic device. The video server may be a YouTube™ server, for example.

In one embodiment, the URL identifies a video relating to the product. For example, in the case of a grocery store that emphasizes health and wellness, scanning a product may result in a Mineo video being played that describes provenance of a food product. In the case of a sporting goods store, scanning a product may result in a Mineo video being played that demonstrates use of product. The Mineo video may in effect be a one minute (although it could be shorter or longer) on-demand TV spot with the viewer being in an ideal position to be influenced positively toward purchase.

The same Mineo video may be presented to all users for a given product. Alternatively, one of many available Mineo videos may be selected based on available information about a given user. If a user is ecology-minded, for example, a video may be selected that emphasizes the eco-friendly aspects of a product.

The mobile application may be used to provide information about “trending” products at a particular location, taking advantage of location capabilities of the mobile electronic device. If videos for a particular product receive a large number of views, are viewed to completion, etc., the product may be identified as trending upward. Social media tools may also be used, allowing users to “like” a video or a product, with such information also contributing to the identification of trending products.

If desired, a promotional mark may be provided on shelf tags, products or product packaging to notify shoppers of the availability of product information in the manner described. The mark may be produced in conjunction with the UPC code or other identifying information, or may be applied as a sticker, or applied by other means. Referring to FIG. 4, in some embodiments, a sticker 401 may incorporate an RFID tag and, at the same time, provide a distinctive visual indication of the availability of additional product information. Stickers incorporating RFID tags are available, for example, from Avery Dennison Corporation.

In one embodiment, when the paper insert for a shelf tag is printed, the information system controlling printing may have information as to which items should be provided with stickers incorporating RFID tags. An outline or other indication may be printed on the paper insert. Store personnel may later manually adhere a RFID sticker to the paper inserts as required. Alternatively, the printer may be equipped to automatically adhere RFID stickers to the paper inserts as required.

In one embodiment, a QR (Quick Response) bar code is provided next to (or on) the promotional mark or sticker in order to direct first-time users or prospective users to explanatory information about how to obtain addition product information. For example, scanning the QR code might result in the following being displayed to the user: “A Mineo™ spot is a short video providing you the latest information about great products. Get it by simply snapping a picture of the product barcode when you see the Mineo logo. Or, if your phone is really hip, tap your phone against a shelf tag that has the Mineo logo. Some products may have only a single Mineo. Others may have many. You may be given the option to choose the Mineo that interests you most. Sometimes, the Mineo may be chosen automatically based on your known interests. To experience, touch GO now!”

In other embodiments, shelf tags may be electronic instead of paper. The same or similar methods as previously described are applicable to electronic shelf tags. For example, the shelf tags may be provided with RFID capabilities, enabling users of mobile electronic devices to tap an electronic shelf tag and receive product information. In this instance, the product information may be a UPC code, a URL, or a combination thereof. Because electronic shelf tags are electronically updated without human intervention, it is easy to write to each electronic shelf tag a Mineo URL. In the case of paper-based shelf tags with RFID stickers, the information retrieved in response to tapping may also be a UPC code, a URL, or a combination of the same. If human intervention is required for updates, then it may be preferable for the information retrieved in response to tapping to be the UPC code, which may then be mapped by a server to the desired URL.

In the case of paper-based shelf tags, UPC and/or URL information may be written to RFID tags by store personnel using a mobile electronic device running a suitable application. In one embodiment, a store clerk uses the mobile electronic device to read from a shelf tag a UPC code or the like. The clerk taps the same shelf tag with the mobile electronic device, causing the UPC information to be written to the RFID tag. Alternatively, or in addition, the UPC code is sent to a server and mapped to the appropriate URL. The URL is returned to the mobile electronic device. The clerk taps the same shelf tag with the mobile electronic device, causing the URL information to be written to the RFID tag.

In still other embodiments, Mineo URL information for each shelf tag may be printed directly in the form of a QR code or the like. In the case of electronic shelf tags, Mineo URL information may be displayed in the form of a QR code or the like.

A flowchart of a method of distributing product information is shown in FIG. 3. In one embodiment, product ID information is captured using a mobile electronic device and is sent to a server. In response, the server retrieves a URL and sends the URL to an appropriate server. That server sends video information to the mobile electronic device.

The product information need not be a video, or only video, but may be static content, interactive content, interactive content including audio and/or video, etc.

The invention may also be embodied as a tangible computer medium comprising instructions for carrying out methods as described above.

What is claimed is:

1. A method of making product information widely available, comprising:
a mobile device capturing product information identifying a product;
sending the product information to a first server;
the first server retrieving a video identifier in response to the product information;
sending the video identifier to a second server; and
the second server, in response to the video identifier, sending video content concerning the product to the mobile device.

2. A method comprising:
prompting a user to image a code with an expectation of receiving video information;
receiving at a server information derived from imaging of the code; and
in response to said information, sending video information to the user.

3. A method comprising:
tagging a shelf with a tag bearing a code associated with a product; and
on or near the tag, providing a prompt for prompting a user to image a code with an expectation of receiving video information;

4. A shelf tag comprising a sticker incorporating an RFID tag, the sticker presenting branding information indicative of the availability of additional product information.

5. A method of making product information widely available, comprising:
a mobile device capturing product information identifying a product;
sending the product information to a server;
retrieving a video identifier in response to the product information; and
in response to the video identifier, sending video content concerning the product to the mobile device.
